(19) United States
(12) Patent Application Publication
(10) Pub. No.: US 2019/0087761 A1
(43) Pub. Date: Mar. 21, 2019

(54) METHOD AND SYSTEM FOR CREATING AND MANAGING COMPLETE CONTINGENT PLANS

(71) Applicant: Billie Wai Guit Tong, Calgary (CA)

(72) Inventor: Billie Wai Guit Tong, Calgary (CA)

(21) Appl. No.: 15/706,597

(22) Filed: Sep. 15, 2017

(51) Int. Cl. G06Q 10/06

(52) U.S. Cl. CPC G06Q 10/0637

(57) ABSTRACT

A system and method for designing, creating, and using thoughtful plans to prepare for contingencies. The planning system has a computing device executing instructions to: display a graphical user interface for presenting contingency topics. Data is requested from a server and displays at least a portion of the requested data within the graphical user interface. User input modifies the requested data to produce modified data that is transmitted to the server. Machine-readable steps cause the computing device to execute steps, sequentially, concurrently, or any combination of sequentially and concurrently. Some of the steps may be: initiate a call; extract a current location and transmit the current location to the server; capture images from a camera and transmit the captured images to the server; capture audio from a microphone and transmit the captured audio to the server using the transceiver; and initiate an alarm from a speaker.

### FIELD OF THE INVENTION

This invention is in the field of contingency planning stored and executed on a computing structure, and more specifically for designing and creating thoughtful plans to prepare for contingencies.

### BACKGROUND

Contingency planning is of value for businesses, hospitals, fire departments, governments, police departments, regulatory organizations, individuals, etc. during situations that comprise of opportunities and/or challenges. Examples may include the creation of contingent plans to align teams controlling operations with associated initiative teams with the intent to maximize value for an organization while maintaining a high level of safety (e.g. for the work, environment, etc.) across operational contingencies. The set of contingency plans may mitigate losses from force majeure. For individuals, there may be personal risks that contingency planning may mitigate, such as if the individual is walking home alone at night. In the medical field, contingent plans may increase the efficacy of decisions where a surgical team is performing surgery and an unexpected event occurs that may affect an outcome of a surgery.

### SUMMARY

As disclosed herein, a planning system for at least one contingency that may comprise a computing device having at least one processor, at least one tangible computer-readable memory, a display, an input device, and a transceiver for communicating over a network. The at least one processor executes computer-readable instructions from the at least one memory. A set of graphical user interfaces may comprise a set of tools enabling grouping of contingencies and creation of a set of plans associated with at least one contingency planning topic may be displayed. Data comprising at least one of profile data, contingency grouping data, plan data, and any combination thereof may be requested. Requested data may be received from at least one server. At least a portion of the requested data within the set of graphical user interfaces may be displayed. User input may be received via the input device for modifying the requested data to produce modified data. Modified data may be transmitted to the at least one server.

At least one of the graphical interfaces may comprise a set of plans comprising the data associated with the at least one contingency planning topic. In some aspects, the set of graphical user interfaces may comprise a set of mechanism for granting a range of access to other users. In other aspects, the set of graphical user interfaces may comprise a set of mechanisms for selecting contingency planning templates.

A set of tools may be available that enable users to group contingencies based on at least one of: at least one entity's awareness of a similar set of events; at least one entity's availability of time; differences in a set of situations relative to a reference set of situations; a set of subject-matters related to the at least one contingency planning topic; at least one entity's lack of awareness of a similar set of situations; and/or at least one entity's unavailability of time.

The plans may comprise: a set of human-readable instructions and at least one machine-readable step configured to be parsed and executed by the at least one processor. The machine-readable steps may configure the at least one processor to execute sequentially, concurrently, or any combination of sequentially and concurrently, at least one of: initiate a call using the transceiver; extract a current location using a global positioning system (GPS) and transmit the current location using the transceiver; capture images from at least one camera and transmit the captured images to the at least one server using the transceiver; capture videos from the at least one camera and transmit the captured videos to the at least one server using the transceiver; capture audio from at least one microphone and transmit the captured audio to the at least one server using the transceiver; display a new graphical interface; execute other applications; and/or generate input useable in other applications.

In another aspect, there is provided a planning system for at least one contingency that may comprise a server having at least one processor, at least one tangible computer-readable memory, a display, and transceiver for communicating over a network. The at least one processor executes computer readable instructions from the at least one memory. Requests for contingency planning data comprising at least one of profile data, contingency grouping data, plan data, and any combination thereof may be received. Requested data from a set of databases may be retrieved. The requested contingency planning data may be transmitted to at least one remotely located computing device. A set of modified data from the at least one remotely located computing device may be received. Modified data may be stored within the set of databases.

In some aspect, the set of databases may comprise a set of plans comprising the plan data associated with the at least one contingency planning topic.

There may be computer-readable instructions from the at least one memory to: receive at least one change in a range of access to other users for the at least one contingency planning topic; and change at least one access permission based on the range of access. There may also be computer-readable instructions from the at least one memory to: receive a request for selected contingency planning template; and transmit the selected contingency planning template to the at least one remotely located computing device. In addition, there may be computer-readable instructions from the at least one memory to: receive the grouping data from the at least one remotely located computing device, wherein the grouping data comprises grouping contingencies based on at least one of: at least one entity's awareness of a similar set of events; at least one entity's availability of time; differences in a set of situations relative to a reference set of situations; a set of subject-matters related to the at least one contingency planning topic; at least one entity's lack of awareness of a similar set of situations; and at least one entity's unavailability of time.

The plans may comprise: a set of human-readable instructions and at least one machine-readable step configured to be parsed and executed by the at least one processor. The machine-readable steps may configure the at least one processor to execute sequentially, concurrently, or any combination of sequentially and concurrently, at least one of: initiate a call using the transceiver; extract a current location using a global positioning system (GPS) and transmit the current location using the transceiver; capture images from at least one camera and transmit the captured images to the at least one server using the transceiver; capture videos from the at least one camera and transmit the captured videos to the at least one server using the transceiver; capture audio from at least one microphone and transmit the captured audio to the at least one server using the transceiver; display a new graphical interface; execute other applications; and/or generate input useable in other applications.

In yet another aspect, there is provided a method for planning for at least one contingency. The method may comprise displaying a set of graphical user interfaces comprising a set of tools enabling grouping of contingencies and creation of a set of plans associated with at least one contingency planning topic; requesting data comprising at least one of profile data, contingency grouping data, plan data, and any combination thereof; receiving the requested data from at least one server; displaying at least a portion of the requested data within the set of graphical user interfaces; receiving user input via an input device for modifying the requested data to produce modified data; and/or transmitting the modified data to the at least one server.

At least one of the set of graphical user interfaces may comprise a set of plans comprising the plan data associated with the at least one contingency planning topic. A range of access may be granted to other users using a set of mechanisms from the set of graphical user interfaces. Contingency planning templates may be selected using a set of mechanisms from the set of graphical user interfaces.

In some aspects, contingencies may be grouped based on at least one of: at least one entity's awareness of a similar set of events; at least one entity's availability of time; differences in a set of situations relative to a reference set of situations; a set of subject-matters related to the at least one contingency planning topic; at least one entity's lack of awareness of a similar set of situations; and/or at least one entity's unavailability of time.

Further adaptations and combinations of the aspects described herein may be apparent to one of skill in the art.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIGS. 1A and 1B are block diagrams of a network of computing devices and a computing structure for executing a contingency planning system to create and manage complete contingent plans;

FIG. 2 demonstrates a user interface for a social interactive interface for interacting with the contingency planning system;

FIG. 3 presents a user interface for grouping contingencies;

FIG. 4 presents a sample having a hierarchy to identify groups of contingencies where a single plan may be sufficient to respond to each group of contingencies;

FIG. 5 presents a user interface for demonstrating creation or editing of a contingency plan executing on one of the computing devices;

FIG. 6 presents another sample having a hierarchy to identify groups of contingencies where a single plan may be sufficient to respond to each group of contingencies;

FIG. 7 presents a user interface for editing and/or creating for another contingency plan;

FIG. 8 presents a user interface for specifying a plan or plans that may be used when adding, modifying, removing, and/or reclassifying plans and/or groups associated with a particular topic;

FIG. 9 presents an additional sample having a hierarchy to identify groups of contingencies where a single plan may be sufficient to respond to each group of contingencies;

FIG. 10 presents a sample having a sequential hierarchy for advanced contingency planning;

FIG. 11 presents a sample for a contingency plan template;

FIG. 12 presents an incentive structure for providing contingency plans; and

FIG. 13 is a flow chart demonstrating contingency plan creation and management.

### DETAILED DESCRIPTION OF THE ILLUSTRATED EMBODIMENTS

As described above, contingencies affect organizations and individuals. Creating effective contingent plans may enable these organizations and/or individuals to make higher quality decisions when facing contingencies. Nevertheless, developing effective contingency plans may experience a number of challenges. For example, creating a finite set of plans to prepare for a large or infinite number of contingencies may be challenging.

Effective contingency plans generally comprise of at least one robust element. In some aspects, a finite number of plans or portions of plans may be used to prepare for a large or infinite number of contingencies. In some aspects, some plans may conflict with other plans. In other aspects, some of the individuals impacted by a plan may not be aware of the plan. In yet other aspects, a prescribed plan may have detrimental effects on one or more individuals and those individuals may act against the goals of the plan. In some aspects, additional elements to the plan may need to be added or removed from existing plans in order to tailor the plan to a particular situation. In some aspects, multiple individuals may be responsible for developing a set of plans. When individuals disagree on elements in the plan, a conflict resolution method may be required and/or a method of aligning the individuals affected by the plan may be used to enhance an efficiency and an effectiveness of an execution of the plan.

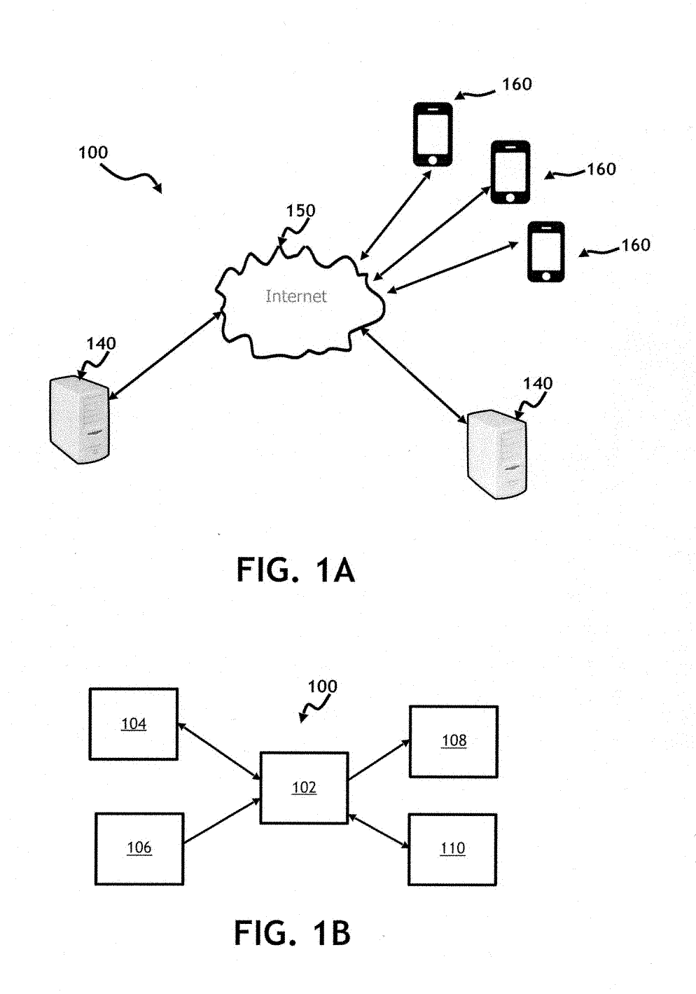

As demonstrated with reference to FIGS. 1A and 1B, there is provided a computing structure 100. The computing structure 100 comprises of a set of computing devices 160 for communication over the Internet 150 with one or more servers 140. Each of the computing devices 160 and/or servers 140, shown particularly in FIG. 1B, comprise one or more processors 102, one or more memories 104, one or more input devices 106 (such as a keyboard, touch screen, and/or mouse), at least one display 108, at least one transceiver 110 for communication over the Internet 150. For each computing device 160, the processor 102 may read and execute instructions stored within the one or more computer-readable memories 104 to display one or more graphical user interfaces (GUI) (e.g. 200, 400, and 500), where each graphical user interface comprises a set of tools for grouping contingencies or creating a set of plans as further described below. Each computing device 160 may also comprise of instructions stored within the memories 104 for requesting and receiving profile data, contingency grouping data, plan data and/or user-provided data from the server 140. Similarly, each computing device 160 may comprise of instructions stored within the memories 104 for transmitting modified profile data, plan data, contingency grouping data, and/or user-provided data to the server 104.

Also demonstrated with reference to FIG. 1B, the at least one server 140 may each have at least one server processor 102, at least one server memory 104, and at least one server transceiver 110 for communication over the Internet 150. For each server 140, the server processor 102 may read and execute instructions stored within the server memory 104 to transmit and/or receive profile data, plan data, contingency grouping data, and/or user-provided data from the computing devices 160 over the Internet 150.

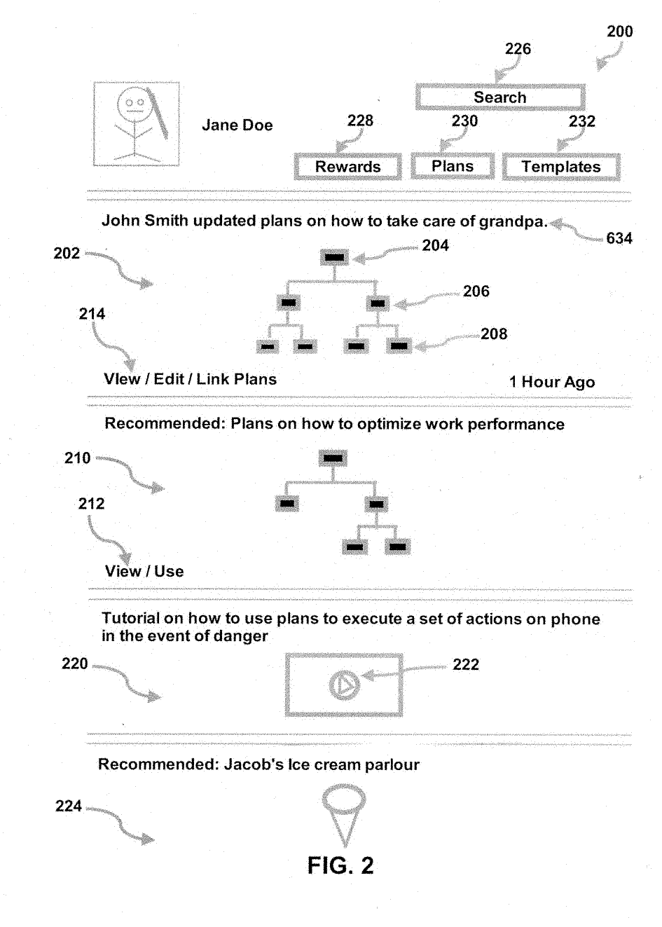

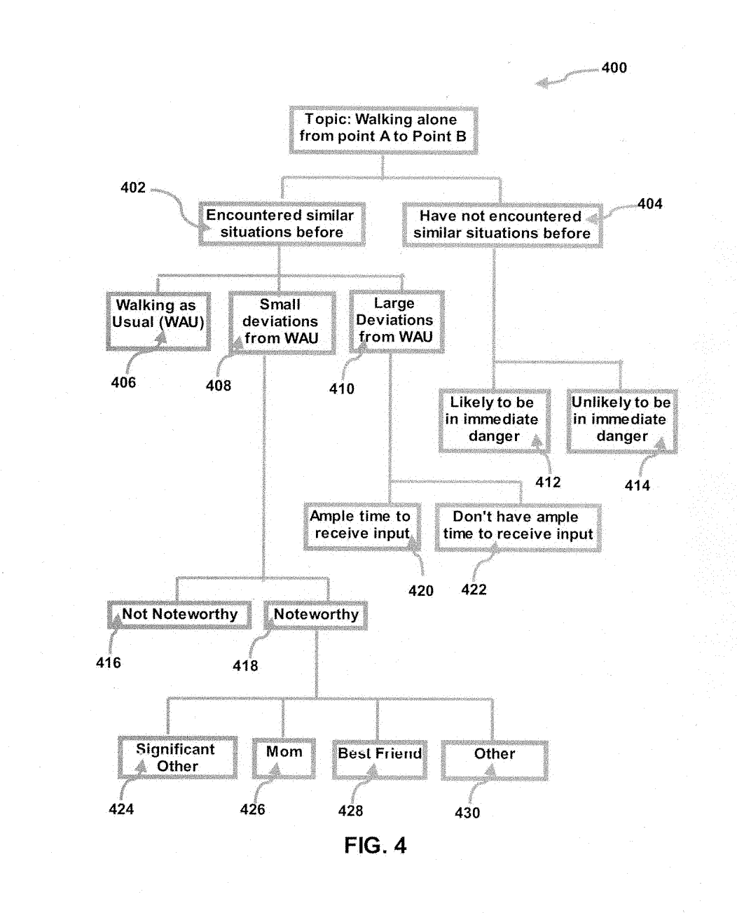

Turning to FIG. 2, a GUI 200 may enable a set of permitted users to engage with one or more of the contingency topics, contingency groupings, and/or associated contingency plans stored in a set of databases on the at least one server 140. In this example, the computing device 160 may display a view 202 of a set of plans associated with the situation topic 634 along with the plurality of tools for grouping or splitting groups of plans. The view 202 may comprise of a tree structure of the contingencies as shown in more detail in FIG. 4. The tree structure of the contingencies may comprise of a number of levels 204, 206, and/or 208. Each of the levels 204, 206, 208 may be a further grouping or a categorization of the contingencies associated with the situation topic 634.

The computing device 160 may also display a set of recommended contingency plan topics with associated contingency groupings, and/or contingency plans 210 from the set of databases on the at least one server 140. The user may then select to view/use 212 the recommended contingency plan 210. The recommended contingency plan 210 may be selected based on previous contingency plans entered by the user, or by selection criteria previously entered by the user. The previous contingency plans and previous selection criteria may be stored in a user's profile data. The computing device 160 may also display video-based tutorials 220, such as a tutorial on how to use plans to execute a set of actions on the computing device 160 in the event of danger. The video 222 may be automatically played or may present a play button for execution by the user. The computing device 160 may also display a recommended location or promotion 224 such as “Jacob's Ice Cream Parlor”.

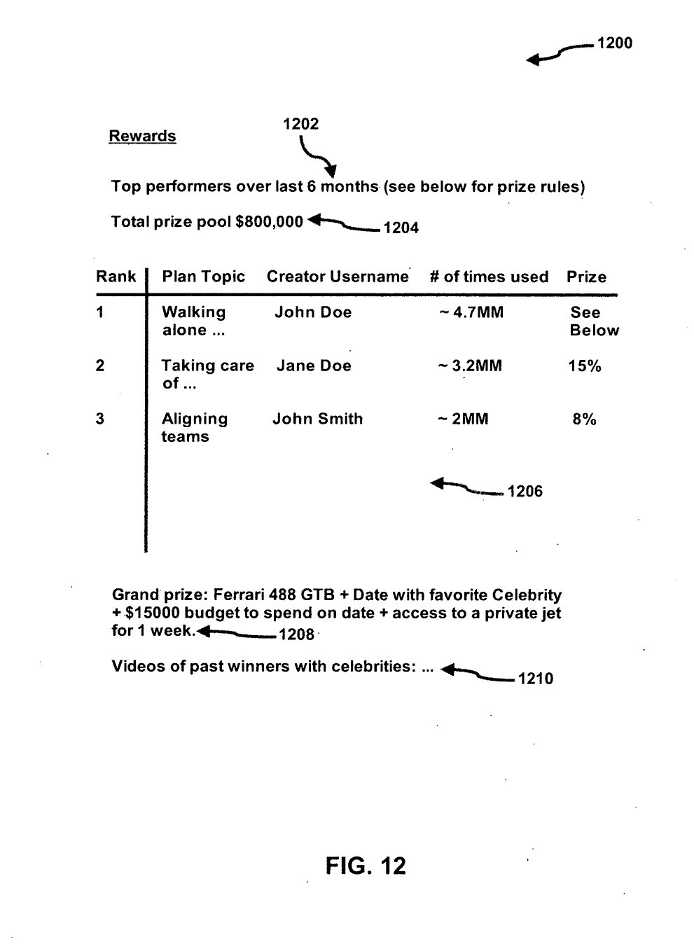

The GUI 200 may additionally comprise of a search box 226 where the user may enter search terms that the at least one server 140 uses to query the complete set of databases or subset of the databases. The user-interface 200 may also provide buttons to navigate between areas of the contingency planning system. For example, a rewards button 228 may cause the user-interface 200 to display rewarding functionality for the contingency plan system as described in further detail with reference to FIG. 12 below. User-generated contingency plan topics, contingency groupings, and/or associated contingency plans may be accessed using the plans button 230. Templates of contingency plan topics with associated contingency groupings, and/or contingency plans may be accessed using the templates button 232.

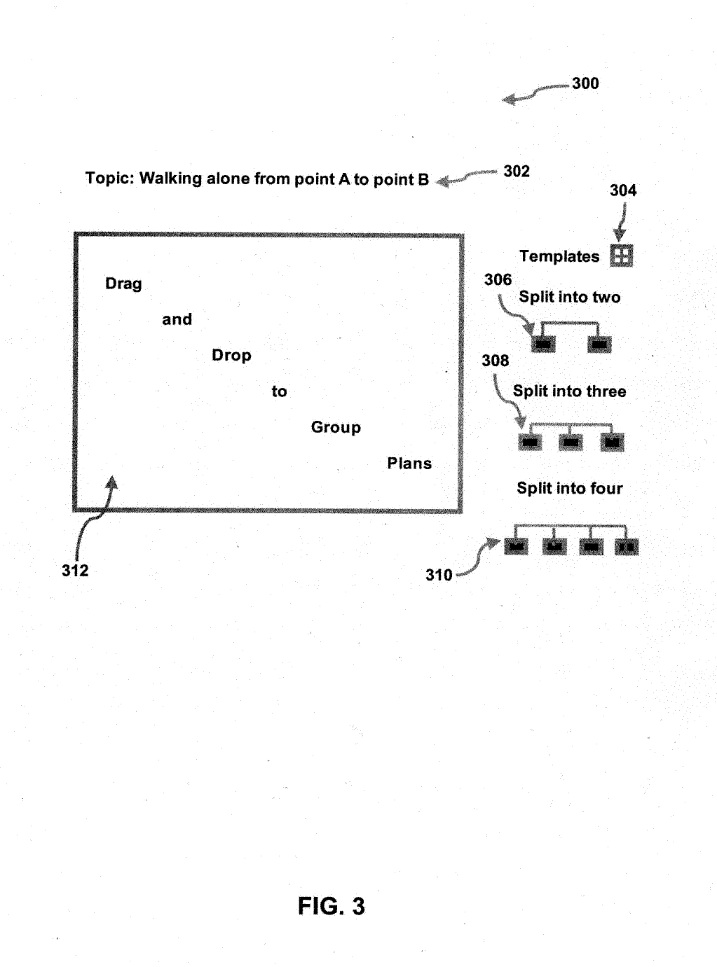

Turning now to FIG. 3, the computing device 160 may present a GUI 300 on the display for a particular topic 302. In this example, the topic is walking along from point A to point B. The GUI 300 may have a drag-and-drop area 312 to group contingencies together. The GUI 300 may also comprise of one or more icons that may split a group of contingencies (e.g. All contingencies associated with Walking alone from Point A to Point B) into two 306, three 308, or four 310 groups. When splitting, the groups may be defined such that there is no overlap in contingencies and the sum of the separated groups equals the contingencies in the group separated (e.g. splitting the total contingencies of the topic into two groups), such as “have time to react” and “no time to react”. In some aspects a set of drop down lists 304 may be present in GUI 300 where the user may select one of the following: “at least one entity's awareness of similar set of event”; “at least one entity's availability of time”; “differences in set of situations relative to a reference set of situations”; “subject-matter related to the topic”; “at least one entity's unawareness of similar set of situations”; and “at least one entity's unavailability of time”. If one is selected from the set of drop down lists in GUI 300 and one of the icons (e.g. 306) that split a group of contingencies is dragged into 312, the name of the groups may be populated automatically with default titles.

Turning now to FIG. 4, a sample hierarchy for the topic 302 of walking alone from point A to point B demonstrates the splitting functionality. FIG. 4 provides a sample where grouping the complete set of contingencies associated with a particular topic based on at least one of the following: at least one entity's awareness of similar set of events; at least one entity's availability of time; differences in set of situations relative to a reference set of situations; subject-matter related to the topic; at least one entity's unawareness of similar set of situations; and at least one entity's unavailability of time may identify a single plan sufficient to prepare for each group of contingencies. The top level may group contingencies based on at least one entity's awareness of similar set of events by for example, classifying the contingencies into: encountered similar situation before 402 and have not encountered similar situation before 404 (e.g. a new situation). The group of contingencies found in “encountered similar situations before” 402, may be divided into subgroups based on differences in set of situations relative to a reference set of situations by for example, classifying the contingencies into: walk as usual (WAU) 406, small deviations from WAU 408, and large deviations from WAU 410. Contingencies associated with small deviations from WAU 408 may then be grouped based on subject-matter related to the topic by for example, classifying the contingencies into: noteworthy 418 or not noteworthy 416. Contingencies associated with noteworthy 418 may then be grouped based on subject-matter related to the topic by for example, classifying the contingencies into: significant other 424, mom 426, best friends 428, or other 430. Contingencies associated with large deviations from WAU 410, may be grouped based on at least one entity's availability by for example, classifying the contingencies into: ample time to receive input from the user 420, or not ample time to receive input 422. Contingencies that have not been encountered before 404, may be grouped based on differences in situation relative to a reference set of situation by classifying for example, the contingencies into: likely to be in immediate danger 412, or unlikely to be in immediate danger 414.

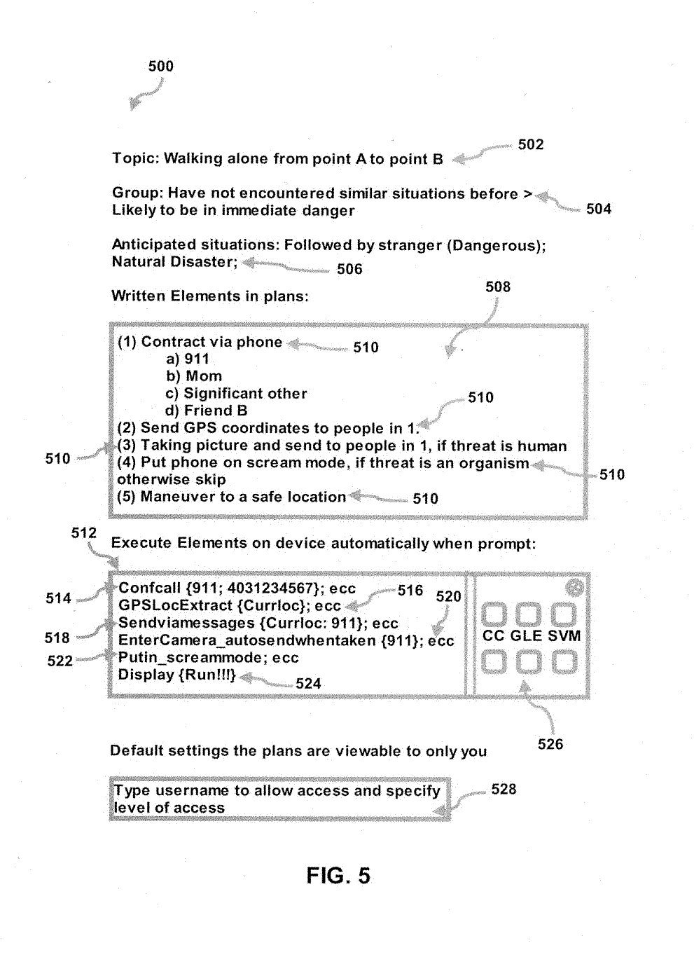

For each of the grouped contingencies (e.g. 408, 418, 424, and 426) a user may right click (or in a touch system, use a “long press” or other gesture). The action may cause the computing device 160 to display a interface 500 identical or similar to FIG. 5. FIG. 5 is a sample interface for a user right clicking on 412 and may include a number of tools for creating a plurality of plans. Each plan may comprise of a plan topic 502, a hierarchy 504 indicating a particular group of contingencies in which a plan may be developed for the interface 500, anticipated situations 506 based on a user and/or entity knowledgeable of the topic 502 may be categorized in the group, written elements 508 of the plan, and executed elements 512 to be executed on the computing device 160. In this example, the written elements 508 may comprise of human readable steps such as “contact via phone”, “send GPS coordinates”, “take picture”, “put phone on scream mode”, and “maneuver to a safe location”. In this example, the executed elements 512 may comprise of a markup language of machine-readable steps to be parsed, such as “Conference call” 514 to simultaneously call a set of numbers on the computing device 160 (e.g. for example, using a Voice-over-Internet-Protocol VoIP). The executed elements 512 may also configure the computing device 160 to extract the current GPS location 516 and send the extracted location 518 to a set of contacts. The executed elements 512 may also configure the computing device 160 to enter into camera mode and automatically send the images to a set of contacts when taken 520. The executed elements 512 may also configure the computing device 160 to initiate audio 522, such as a person screaming for help. The executed elements 512 may also display 524 additional instructions such as run.

In some aspects, the user may create complete contingent plans for a particular topic by only creating plans for the lowest levels groups (e.g. For the sample provided in FIG. 4: 406, 416, 424, 426, 428, 430, 420, 422, 412, and 414 are the lowest level groups) in a hierarchy used to identify groups of contingencies for which a single plan may be sufficient to respond to each group of contingencies.

In some aspects, the executed elements 512 may be executed concurrently. In this example, Conference call, extraction of current GPS location, sending current GPS location, enter camera mode, and put into scream mode are executed concurrently. In some aspects, the computing device 160 may favour certain elements, executed concurrently. In this example, entering into camera mode 520 may be favoured over the other elements, executed concurrently and initiates a display (e.g. 514, 516, and 518) on the computing device 160, because 520 was entered in the latter parts of 512. Upon execution, the camera mode display may occupy the majority of the display of the computing device 160, and the remaining elements executed concurrently may be hidden and/or occupies a minority of the display of the computing device 160. Elements not executed concurrently, such as “display run” 524 may be accessed using a swipe (a button (e.g. next) or other gestures). In some aspects, the swipe may enable the user to move to the next or previous set of elements. In some aspects, set of elements may be determined by whether the elements are executed concurrently.

The GUI 500 may further comprise of a palette of functions 526 that permit the user to drag-and-drop the functions from the palette 526 into the automated process window 512. The GUI 500 may also comprise of a permissions window 528 having a set of mechanisms that provides the user with an ability to give a range of access to the plan to other users.

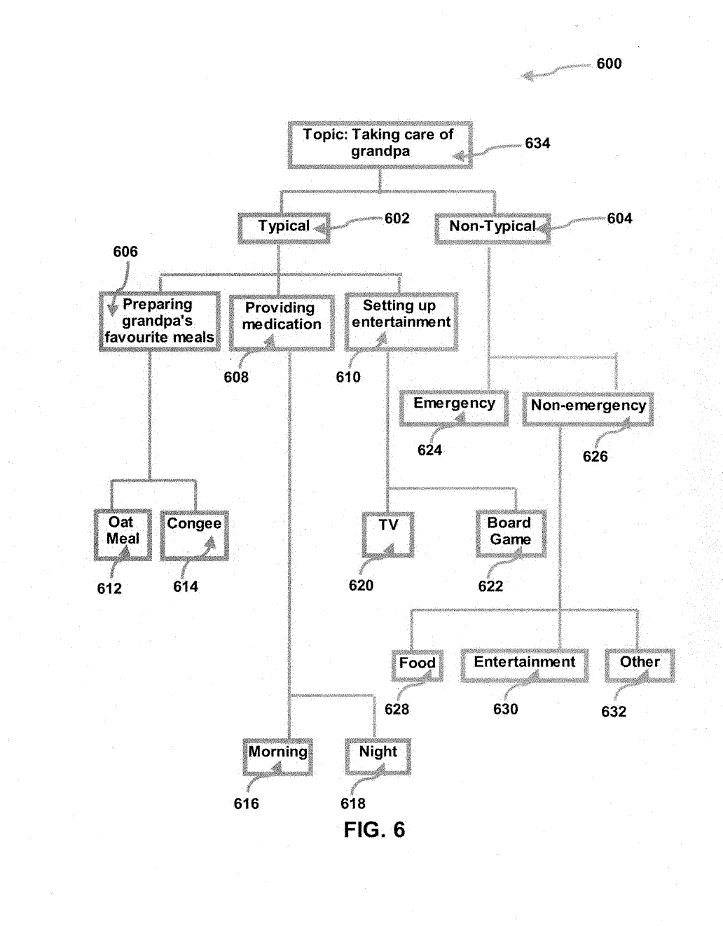

FIG. 6 provides an additional sample 600 in which grouping the complete set of contingencies associated with a given topic based on one or more of the following: at least one entity's awareness of similar set of events; at least one entity's availability of time; differences in set of situations relative to a reference set of situations; subject-matter related to the topic; at least one entity's unawareness of similar set of situations; and at least one entity's unavailability of time may identify a single effective plan for each group of contingencies. For the topic “taking care of grandpa” displayed in view 202 of FIG. 2, the complete set of contingencies associated with the topic may be grouped based on the difference in set of situations relative to a reference set of situations by for example, classifying the contingencies into: typical plans 602 and atypical plans 604. Contingencies associated with the typical plan 602 may then be grouped based on subject-matter related to the topic by for example, classifying the contingencies into: “preparing grandpa's favorite meal” 606, “providing medication” 608, and/or “setting up entertainment” 610. Contingencies associated with preparing grandpa's favourite meal 606 may be further grouped based on subject-matter related to the topic by for example, classifying the contingencies into: preparing “oatmeal” 612, and preparing “congee” 614. Contingencies associated with providing medication 608, may be grouped based on differences in set of situations relative to a reference set of situations, by for example, classifying the contingencies into: “morning” medication 616 and “night” medication 618. Contingencies associated with setting up entertainment 610, may be grouped based on subject-matter related to the topic by for example, classifying the contingencies into: “tv” 620 or setting up a “board game” 622. Contingencies classified as non-typical 604, may be further categorized based on differences in set of situations relative to a reference set of situations by for example, classifying the contingencies into: “emergency” 624 and “non-emergency” 626. Contingencies classified as non-emergency 626 may also be grouped based on subject-matter related to the topic by for example, classifying the contingencies into: food preparation 628, entertainment 630, or other 632.

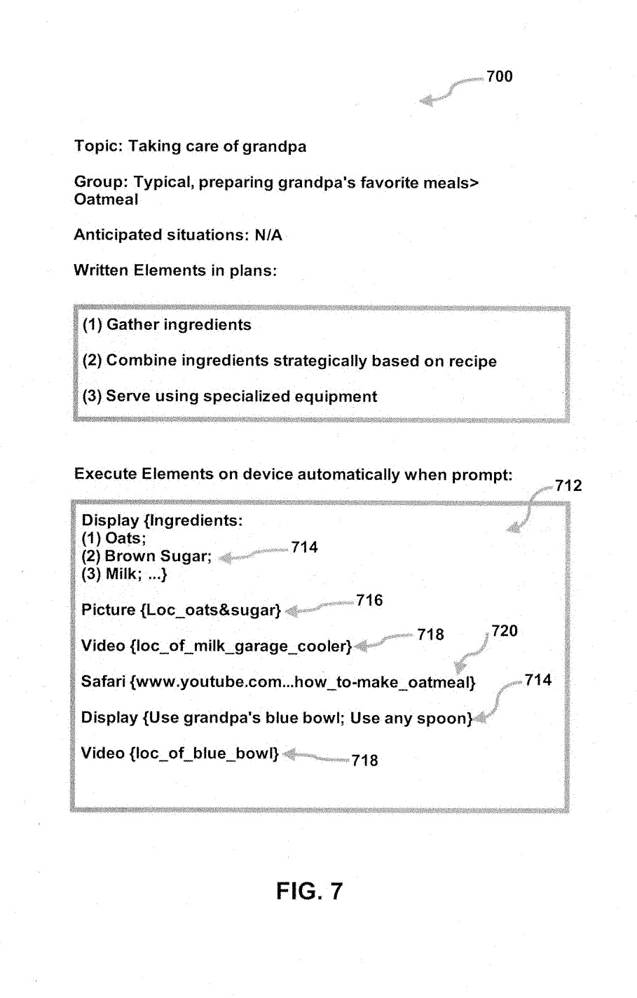

For each of the grouped contingencies in FIG. 6. (e.g. 606, 612, 616, and 630) a user may right click (or in a touch system, use a “long press” or other gesture). The action may cause the computing device 160 to display a graphical user interface 700. Many of the features in FIG. 7 are similar as to those in FIG. 5, and therefore will not be further described. In this example, the executed elements 712 may comprise of machine-readable steps, such as display steps 714 “display ingredients” to display the ingredients on the display of the computing device 160. The executed elements 712 may also configure the computing device 160 to show a set of pictures 716 of a location of the ingredients such as the location of the oats and sugar. The executed elements 712 may also configure the computing device 160 to show video 718 of the location of some of the ingredients such as the location of the milk. The executed elements 712 may also configure the computing device 160 to load a webpage 720, such as a video of how to make oatmeal on Youtube. The executed elements 712 may also display 714 additional instructions such as which bowl to use and video 718 of where the bowl is located.

In some aspects, upon execution a swipe (forward/back button, other buttons, or other gestures) may enable a user to move to the next or previous set of elements. For example, upon execution of the elements in 712, the computing device 160 may display the ingredients on the display. A swipe to the left may cause the computing device 160 to display a picture of where oats and sugar are located. Another swipe to the left may cause the computing device 160 to display a video of the location of the milk. A swipe to the right may cause the computing device 160 to go back to displaying the picture of where oats and sugar are located.

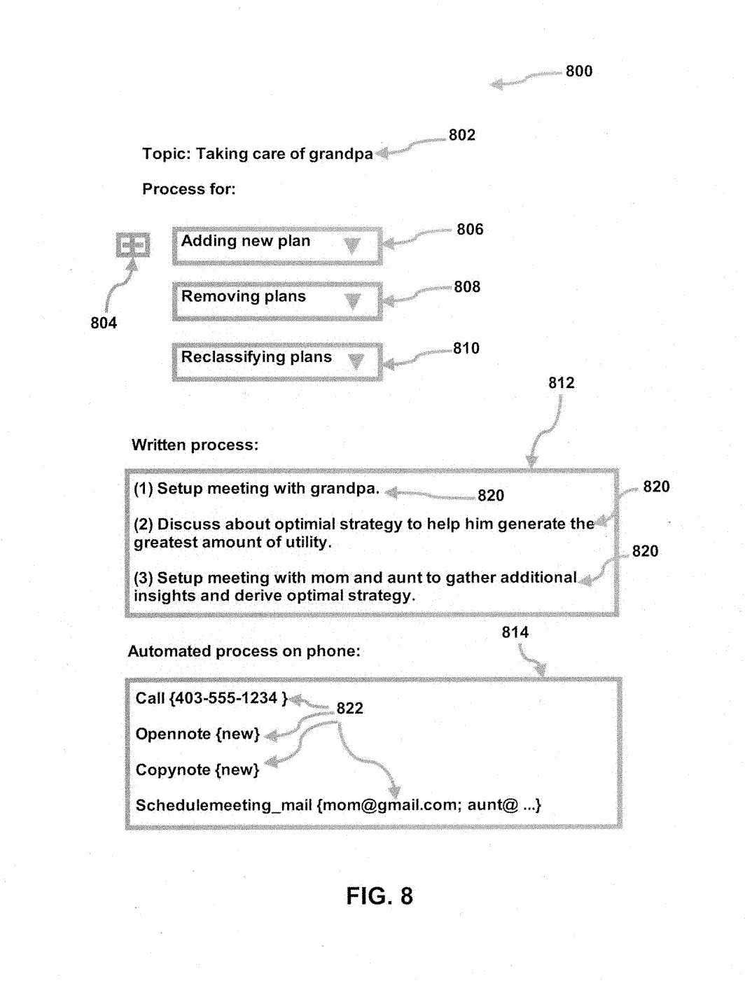

Turning now to FIG. 8, the GUI 800 for creating a single process or multiple processes for adding, removing, modifying and reclassifying plans (and/or contingency groups) may comprise of a topic 802, in this example, “Taking care of grandpa”. In some aspects, the display shown in GUI 600 may provide a user a channel (e.g. button) to access GUI 800. An addition icon may add a set of mechanisms, such as dropdown boxes, 804. The dropdown boxes 804 may enable users to select add, remove, modify, reclassify, or other. In this example, the process specified in 812 and 814 is applicable for adding new plans 806, removing plans 808, and/or reclassifying plans 810.

Within the written process window 812, the user may enter one or more steps 820 in human readable form. In this example, the steps 820 are “setup meeting with grandpa”, “discuss about optimal strategy to help him generate greatest amount of utility”, and “setup meeting with mom and aunt to gather additional insights and derive optimal strategy”. In some aspects, an automated process on computing device window 814 may also be displayed for receiving instructions capable of being parsed by a program executing on the computing device 160. In the window 814, one or more steps 822 may be entered that may be automatically executed by a computing device 160. In some aspects, a palette similar or identical to 526 may be available to select functions that can be automatically executed on the computing device 160. In this example, the steps 822 may be call grandpa at “{403-555-1234}”, open note and take notes while discussing about the optimal strategy to help grandpa generate the greatest amount of utility, copy the note content, and schedule a meeting with mom and aunt via email to discuss about the optimal strategy to help grandpa generate the greatest amount of utility.

In some aspects, the user may specify different processes for adding, removing, modifying, and/or reclassifying plans (and/or contingency groups) by creating multiple processes using GUI 800.

Other examples of automatically executable elements specifiable in 512, 712, 814 may comprise of: opening other applications; collecting GPS related data; collecting non-GPS related data from the computing device; opening a new interface within an application on the computing device 160; activating a prompt in the application that allows users affected by the set of elements to choose whether or not to execute an interdependent plan; opening a new interface outside of the application; generating input useable in the application; generating input useable in other applications; generating input useable for in-built functions on the computing device 160; executing tasks in other applications; and/or executing built-in functions on the computing device 160.

In some aspects, the user may link related plans with other users. For example, upon initiation of the automated elements, in the midst of the execution of the automated elements, or completion of the execution of the automated elements in 512, a prompt may notify a user with a linked plan, and may enable the user to initiate the linked plan. In other aspects, other specified users (e.g. The user granting access via 528), may also add, view, modify, and/or delete the users' contingency plans.

In some aspects, GUI 300 may contain a set of drop down lists that enable the user to select which category the topic belong in (e.g. Personal>Walking). A set of search algorithms executing on the server 140 may also be used to automatically group particular topics within the set of databases.

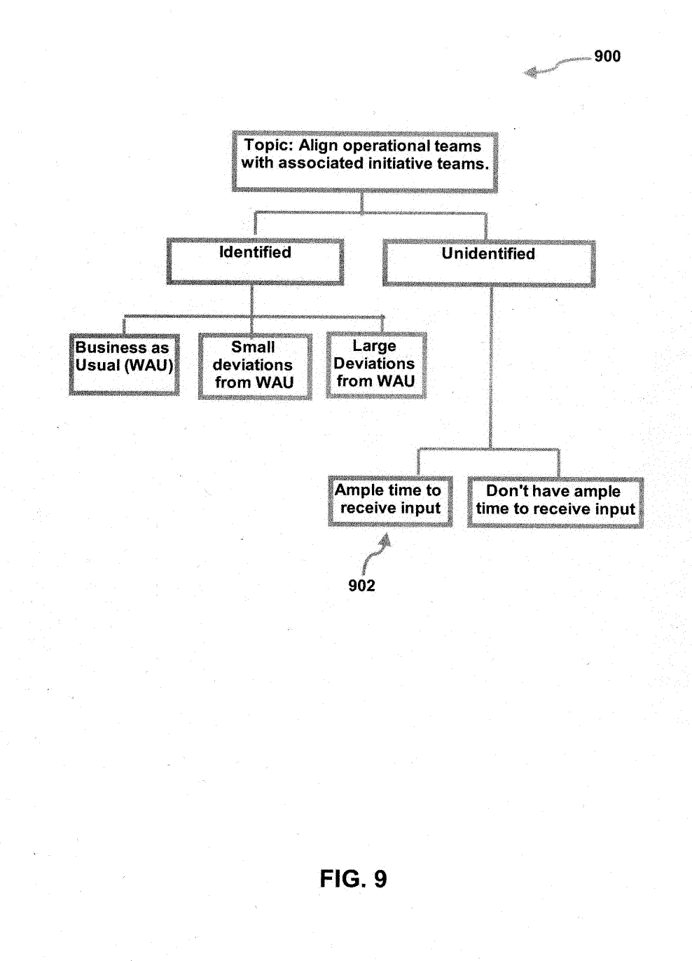

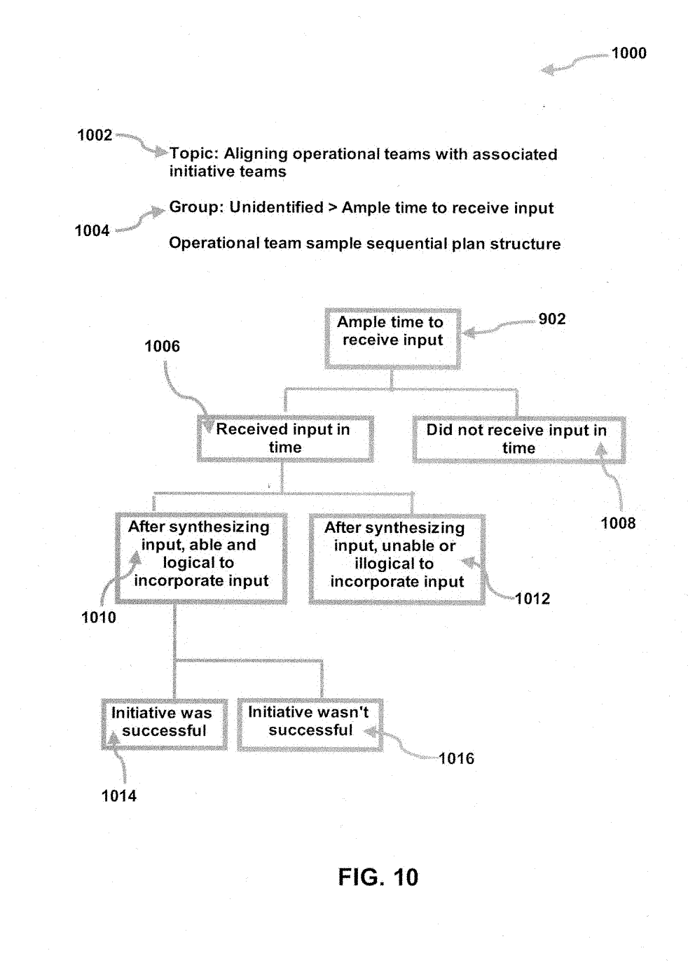

Another example of a contingency planning is presented in FIGS. 9 to 11. Many of the features in FIG. 9 are similar as to those in FIG. 5, and therefore will not be further described. FIG. 10 is a sample hierarchy used for advanced contingency planning. GUI 1000 may comprise of a plan topic 1002, a hierarchy 1004 indicating a particular group of contingencies in which a sequential hierarchy may be developed for in interface 1000. GUI 1000 may be access by left clicking, in this example 902, which may cause a context menu to be displayed containing an option to add sequential plans. Clicking on the add sequential plans option enables the user to access GUI 1000. In some aspect, other gestures, buttons, options, and/or actions may enable the user to access GUI 1000. For the subgroup “ample time to receive input” 902, the contingency plans may be grouped based at least one entity's available of time by for example, classifying the contingencies into: receive input in time 1006 and do not receive input in time 1008. The group of contingencies in “received input in time” 1006 may then be grouped based on differences in set of situations relative to a reference set of situations by for example, classifying the contingencies into: after synthesizing input, able and logical to incorporate input 1010 and after synthesizing input, unable or illogical to incorporate input 1012. The group of contingencies in “after synthesizing input, able and logical to incorporate input” 1010 may then be grouped based on subject matter related to the topic by for example, classifying the contingencies into: initiative was successful 1014 and initiative was not successful 1016.

For each of the grouped contingencies in FIG. 10. (e.g. 1006, 1008, 1010, 1012, 1014, and 1016) a user may right click (or in a touch system, use a “long press” or other gesture). The action may cause the computing device 160 to display an interface similar to 500 (or 700).

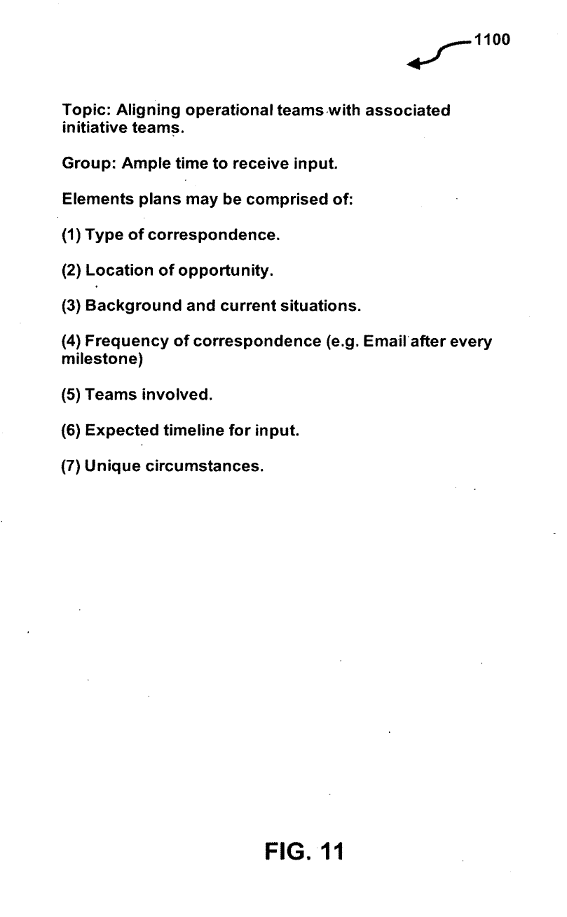

FIG. 11 provides a sample plan template for the contingency group “ample time to receive input” 902 for the topic “aligning operational teams with associated initiative teams”. Plan templates may contain written and executable elements as shown in FIG. 5 and FIG. 7, or provide suggested elements 1102 as shown in FIG. 11.

The computing structure 100 may provide indication to a set of users (e.g. The user that did not follow the plan and a user that has a linked plan may receive indication) when plans are not followed. For example, a prompt may indicate that a user did not follow the plan. Alternatively, a summary page may provide statistics on a user's tendency to follow plans.

In some aspects, a GUI similar to 800 may be used to define a process or processes used when plan are not followed. An addition icon similar to 804 may add a set of dropdown boxes. The dropdown boxes may enable users to select reasons why plans are not followed, for example plans are not followed: due to one or more human errors; anticipated adverse impact to the user(s) affected by the contingency plan; one or more physical constraints; one or more technological constraints; one or more emotional constraints; one or more mental constraints; unwillingness to follow the contingency plan; and/or any combination thereof.

According to some aspects, the user may store their particular contingency plans, contingency plan topics, and grouping of contingencies within a set of databases. Other users may be permitted access to view, modify, add, and/or delete the users contingency plans, contingency plan topics, and/or grouping of contingencies based on whether the other user has met certain default requirements specified. The originating user may withdraw permissions granted to other users. In some aspects, the user may grant permissions to groups of users (e.g. All users may view). In other aspects, the user may grant permission to view all contents of a specified contingency plan topic (e.g. In GUI 300 a box similar or identical to 528 may be present).

In some aspects, there is provided an incentive system 1200 that provides incentive for users to share contingency plans. The rewards may be time limited 1202 such as over 6 months and provide a total prize pool 1204. Each of the topics may be ranked in a list 1206 by the number of times that the contingency plan has been used by others. A grand prize may be presented 1208 and videos of past winners along with videos may be provided 1210.

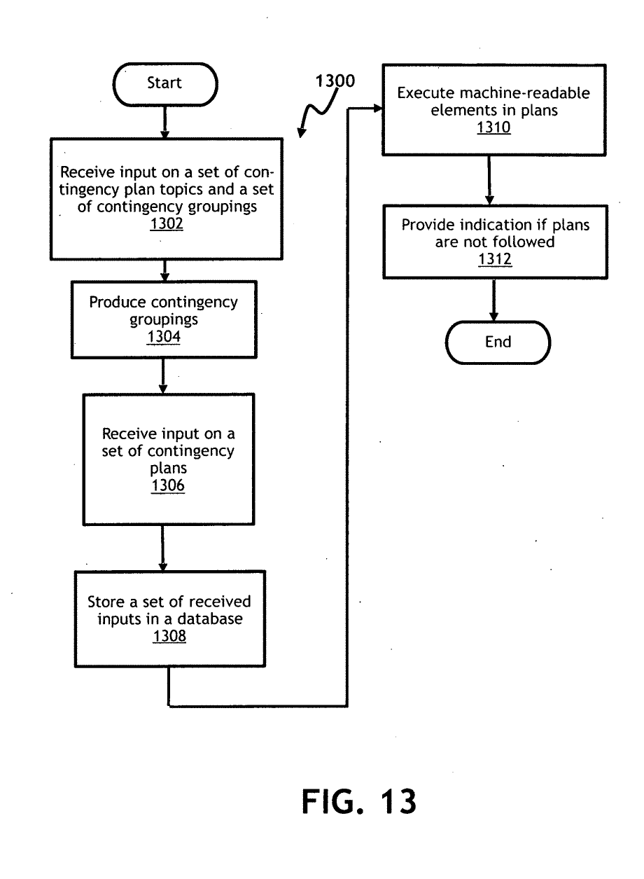

FIG. 13 presents an example flowchart 1300 for a complete contingent plan creation and management system. The process 1300 begins by receiving input on a set of contingency plan topics and a set of contingency groupings via a GUI identical or similar to 300 over a network 106 from one of the computing devices 160 at step 1302. Contingency groupings may be determined based at least in part on the input received in step 1302 at step 1304. The process 1300 continues by receiving input on contingency plans via a set of GUIs (e.g. The GUIs may be identical or similar to 500, 700, and/or 800) (step 1306). The process 1300 may then store a set of the received inputs in a set of databases (step 1308); execute machine-readable elements in plans when prompt (step 1310); and provide indication if plans are not followed (step 1312).

In some aspects, contingency topics, contingency groupings, and/or contingency plans may be created collaboratively. The determination of elements in contingency topics, contingency groupings, and/or contingency plans when more than one entity is involved may be completed through mutual agreement. Mutual agreement may mean that more than one entity involved believes that at least part of the elements in the contingency topic, contingency groupings, and/or contingency plans should be used.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention. Each aspect presented herein may be used in any and all combinations.

What is claimed is:

1. A planning system for at least one contingency comprising a computing device having at least one processor, at least one tangible computer-readable memory, a display, an input device, and a transceiver for communicating over a network; the at least one processor executing computer-readable instructions from the at least one memory to:
display a set of graphical user interfaces comprising a set of tools enabling grouping of contingencies and creation of a plurality of plans associated with at least one contingency planning topic;
request data comprising at least one of profile data, contingency grouping data, plan data, and any combination thereof;
receive the requested data from at least one server;
display at least a portion of the requested data within the set of graphical user interfaces;
receive user input via the input device for modifying the requested data to produce modified data; and
transmit the modified data to the at least one server.

2. The planning system according to claim 1, wherein at least one of the set of graphical interfaces comprises a set of plans comprising the plan data associated with the at least one contingency planning topic.

3. The planning system according to claim 1, wherein at least one of the set of graphical user interfaces further comprises a set of mechanisms for granting a range of access to other users.

4. The planning system according to claim 1, wherein at least one of the set of graphical user interfaces further comprises a set of mechanisms for selecting contingency planning templates.

5. The planning system according to claim 1, wherein the tools enable users to group contingencies based on at least one of:
at least one entity's awareness of a similar set of events;
at least one entity's availability of time;
differences in a set of situations relative to a reference set of situations;
a subject-matter related to the at least one contingency planning topic;
at least one entity's lack of unawareness of a similar set of situations; and
at least one entity's unavailability of time.

6. The planning system according to claim 1, wherein the plans comprises: a set of human-readable instructions and at least one machine-readable step configured to be parsed and executed by the at least one processor.

7. The planning system according to claim 6, wherein the machine-readable steps configure the at least one processor to execute sequentially, concurrently, or any combination of sequentially and concurrently, at least one of:
initiate a call using the transceiver;
extract a current location using a global positioning system (GPS) and transmit the current location using the transceiver;
capture images from at least one camera and transmit the captured images to the at least one server using the transceiver;
capture videos from the at least one camera and transmit the captured videos to the at least one server using the transceiver;
capture audio from at least one microphone and transmit the captured audio to the at least one server using the transceiver;
display a new graphical interface;
execute other applications; and
generate input useable in other applications.

8. A planning system for at least one contingency comprising a server having at least one processor, at least one tangible computer-readable memory, a display, and a transceiver for communicating over a network; the at least one processor executing computer-readable instructions from the at least one memory to:
receive requests for contingency data comprising at least one of profile data, contingency grouping data, plan data, and any combination thereof;
retrieving the requested data from a set of databases;
transmitting the requested data to at least one remotely located computing device;
receiving a set of modified data from the at least one remotely located computing device; and
storing the modified data within the set of databases.

9. The planning system according to claim 8, wherein the set of databases comprises a set of plans comprising the plan data associated with the at least one contingency planning topic.

10. The planning system according to claim 8, further comprises computer-readable instructions from the at least one memory to: receive at least one change in a range of access to other users for the at least one contingency planning topic; and change at least one access permission based on the range of access.

11. The planning system according to claim 8, further comprises computer-readable instructions from the at least one memory to: receive a request for a selected contingency planning template; and transmit the selected contingency planning template to the at least one remotely located computing device.

12. The planning system according to claim 8, further comprises computer-readable instructions from the at least one memory to: receive the grouping data from the at least one remotely located computing device, wherein the grouping data comprises grouping contingencies based on at least one of:
at least one entity's awareness of a similar set of events;
at least one entity's availability of time;
differences in a set of situations relative to a reference set of situations;
a subject-matter related to the at least one contingency planning topic;
at least one entity's lack of unawareness of a similar set of situations; and
at least one entity's unavailability of time.

13. The planning system according to claim 8, wherein the plan data comprises: a set of human-readable instructions and at least one machine-readable step configured to be parsed and executed.

14. The planning system according to claim 11, wherein the machine-readable steps are to be execute sequentially, concurrently, or any combination of sequentially and concurrently, by the at least one remotely located computing device in order to execute at least one of:
initiate a call;
extract a current location using a global positioning system (GPS) and transmit the current location to the at least one server;
capture images from at least one camera and transmit the captured images to the at least one server;
capture videos from the at least one camera and transmit the captured videos to the at least one server;
capture audio from at least one microphone and transmit the captured audio to the at least one server;
display a new graphical interface;
execute other applications; and
generate input useable in other applications.

15. A method of planning for at least one contingency comprises:
displaying a set of graphical user interfaces comprising a set of tools enabling grouping of contingencies and creation of a plurality of plans associated with at least one contingency planning topic;
requesting data comprising at least one of profile data, contingency grouping data, plan data, and any combination thereof;
receiving the requested data from at least one server;
displaying at least a portion of the requested data within the set of graphical user interfaces;
receiving user input via an input device for modifying the requested data to produce modified data; and
transmitting the modified data to the at least one server.

16. The method according to claim 15, wherein at least one of the set of graphical interfaces comprises a set of plans comprising the plan data associated with the at least one contingency planning topic.

17. The method according to claim 15, further comprises granting a range of access to other users using a set of mechanisms from the set of graphical user interfaces.

18. The method according to claim 15, further comprises selecting contingency planning templates using a set of mechanisms from the set of graphical user interfaces.

19. The method according to claim 1, further comprises grouping contingencies based on at least one of:
at least one entity's awareness of a similar set of events;
at least one entity's availability of time;
differences in a set of situations relative to a reference set of situations;
a subject-matter related to the at least one contingency planning topic;
at least one entity's lack of unawareness of a similar set of situations; and
at least one entity's unavailability of time.
